(19) United States
(12) Patent Application Publication
(10) Pub. No.: US 2019/0171922 A1
(43) Pub. Date: Jun. 6, 2019

(54) RFID TAG

(71) Applicant: TOSHIBA TEC KABUSHIKI KAISHA, Tokyo (JP)

(72) Inventor: Naohiro Matsushita, Mishima Shizuoka (JP)

(21) Appl. No.: 16/200,719

(22) Filed: Nov. 27, 2018

(30) Foreign Application Priority Data
Dec. 1, 2017 (JP) 2017-231796

(51) Int. Cl. G06K 19/077

(52) U.S. Cl. CPC G06K 19/07773; H01Q 1/2225

(57) ABSTRACT

According to one embodiment, an RFID tag includes a plurality of antenna elements, a switch, and a control circuit. The switch is inserted between the plurality of antenna elements. The control circuit turns off the switch until a specified time elapsed after responding to radio waves from a reader device.

### CROSS-REFERENCE TO RELATED APPLICATIONS

This application is based upon and claims the benefit of priority from Japanese Patent Application No. P2017-231796, filed on Dec. 1, 2017, the entire contents of which are incorporated herein by reference.

### FIELD

Embodiments described herein relate generally to an RFID tag and methods related thereto.

### BACKGROUND

A tag (RFID tag) using radio frequency identification (RFID) technology receives and responds to radio waves from a reader device. The RFID tag sets a session time such that the reader device does not redundantly read the same RFID tag. For example, when the RFID tag responds to the reader device, responding to the reader device is prohibited until the session time elapsed. Therefore, the RFID tag prevents a useless response signal from overlapping a response signal of another RFID tag not to interfere with reading.

However, if a plurality of RFID tags are densely present, there are two interference phenomena of hindering reading of the RFID tag by the reader device. A first interference phenomenon is that a plurality of RFID tags share radio waves with finite power sent by the reader device, and each RFID tag has insufficient power. A second interference phenomenon is that the antennas of a plurality of RFID tags are electromagnetically coupled to each other to cause impedance mismatching between the antennas and an IC chip. In this case, once high-frequency power captured by the antenna is reflected at a connection point with the IC chip and is returned to the antenna to be re-radiated, thereby causing interference in reception by the reader device.

### DESCRIPTION OF THE DRAWINGS

FIG. 1 is a view illustrating a configuration example of an RFID tag according to a first embodiment;

FIG. 2 is a view for describing shift of a resonant frequency in an antenna of the RFID tag according to the first embodiment;

FIG. 3 is a block diagram illustrating the configuration example of the RFID tag; and

FIG. 4 is a view illustrating a configuration example of an RFID tag according to a second embodiment.

### DETAILED DESCRIPTION

An exemplary embodiment provides an RFID tag capable of reducing deterioration of reading efficiency by a reader device.

In general, according to one embodiment, an RFID tag includes a plurality of antenna elements, a switch, and a control circuit. The switch is inserted between the plurality of antenna elements. The control circuit turns off the switch until a specified time elapsed after responding to radio waves from a reader device. In another embodiment, a method of mitigating interference when reading an RFID tag from a group of RFID tags densely arranged involves turning off a switch positioned between a plurality of antenna elements until a specified time elapses after responding to radio waves from a reader device.

Hereinafter, embodiments will be described with reference to the drawings.

It is assumed that the RFID tags according to first and second embodiments described below are attached to articles to be managed (such as books, products, parts, or the like). Information, such as an ID, of the RFID tag attached to the article is read by a reader device. In addition, the articles attached with the RFID tags are densely arranged and the reader device is used to read the RFID tags arranged at high density. A reader device used to read an RFID tag attached to each book placed in a library is exemplified. Since a plurality of books are aligned and arranged on shelves in the library, the RFID tags attached to the books are densely present. The RFID tags according to the first and second embodiments described below are reliably read by the reader device even when being densely present.

### First Embodiment

First, an RFID tag according to a first embodiment will be described.

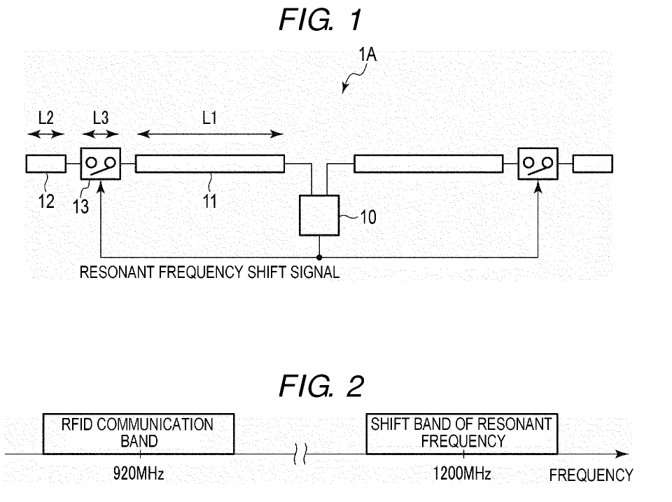

FIG. 1 is a view illustrating a configuration example of an RFID tag 1A according to the first embodiment.

The RFID tag 1A includes an IC chip 10, a first antenna element 11, a second antenna element 12, and a high-frequency switch 13. In the first embodiment, the RFID tag 1A will be described as a passive-type tag.

The IC chip 10 includes various types of control circuits, a power supply circuit, a memory, and the like. The IC chip 10 includes a pair of antenna terminals connecting a balanced antenna. The IC chip 10 generates power for operation from radio waves received by the antenna connected to the antenna terminal. In addition, the IC chip 10 operates by the power generated from the received radio waves and performs wireless communication with a reader device through the antenna connected to the antenna terminal. That is, the IC chip 10 is a passive-type chip which operates by the power generated from the radio waves sent by the reader device and performs wireless communication with the reader device.

The first antenna element 11 and the second antenna element 12 are linked through the high-frequency switch 13. In other words, the first antenna element 11 and the second antenna element 12 are divided by the high-frequency switch 13. The first antenna element 11 is connected to each of the pair of antenna terminals of the IC chip 10. The first antenna element 11 and the second antenna element 12 configure an antenna having a predetermined length when being connected through the high-frequency switch 13.

The high-frequency switch 13 is a switch for switching the electrical connection state between the first antenna element 11 and the second antenna element 12. For example, when the high-frequency switch 13 is turned on, the first antenna element 11 and the second antenna element 12 are electrically connected. When the high-frequency switch 13 is turned off, the first antenna element 11 and the second antenna element 12 are electrically disconnected. The high-frequency switch 13 may switch the electrical connection state between the first antenna element 11 and the second antenna element 12 according to a control signal from the IC chip 10. For example, the high-frequency switch 13 is formed of a semiconductor chip such as a gallium arsenide FET having small insertion loss in a high-frequency region.

The first antenna element 11 and the second antenna element 12 connected through the high-frequency switch 13 are designed depending on a frequency band (RFID communication band) used in communication with the reader device. For example, a wavelength at the center frequency of the RFID communication band is set to λ. The wavelength λ does not indicate a physical length in air but indicates the wavelength of the electrical length obtained by multiplying the physical length by a shortening rate according to a specific dielectric constant of a base material (for example, a PET film, a printed board, or the like) forming a conductor serving as an antenna. In this case, a λ/4 antenna is connected to each of the antenna terminals of the IC chip 10 to form a λ/2 dipole-type antenna with the both antennas.

That is, a total length from the first antenna element 11 connected to one antenna terminal to the second antenna element 12 through the high-frequency switch 13 is λ/4. Therefore, the RFID tag 1A is formed such that the entire length of the antenna connected to the pair of antenna terminals of the IC chip 10 becomes λ/2. In the example illustrated in FIG. 1, the sum of the length L1 of the first antenna element 11, the length L2 of the second antenna element L2, and the length L3 of the high-frequency switch 13 is designed to be λ/4.

FIG. 1 schematically illustrates the electrical connections between the parts. The first antenna element 11, the high-frequency switch 13, and the second antenna element 12 are successively linked to be connected to the IC chip 10. Accordingly, the total length of the antenna connected to the IC chip 10 is the total length (L1+L2+L3) of the first antenna element 11, the high-frequency switch 13, and the second antenna element 12.

As illustrated in FIG. 1, when the high-frequency switch 13 is turned on, the first antenna element 11 and the second antenna element 12 are electrically connected through the high-frequency switch 13. Accordingly, when the high-frequency switch 13 is turned on, the length of the antenna connected to one antenna terminal of the IC chip 10 (the total length of the first antenna element 11, the high-frequency switch 13, and the second antenna element 12) becomes λ/4. Therefore, the entire length of the RFID tag 1A becomes λ/2 as a whole antenna.

In contrast, when the high-frequency switch 13 is turned off, the first antenna element 11 and the second antenna element 12 are electrically disconnected by the high-frequency switch 13. Accordingly, when the high-frequency switch 13 is turned off, the length of the antenna connected to one antenna terminal of the IC chip 10 becomes shorter than λ/4. Therefore, the entire length of the antenna of the RFID tag 1A becomes shorter than λ/2.

Next, the design of the antenna used in the above-described RFID tag 1A will be described.

In the RFID tag 1A, when the high-frequency switch 13 is turned on, the length of the antenna connected to the IC chip 10 becomes λ/2 and communication with the reader device at the RFID communication band is performed. In contrast, when the high-frequency switch 13 is turned off, in the RFID tag 1A, the length of the antenna connected to the IC chip 10 becomes shorter. When the length of the antenna becomes shorter than λ/2 due to the high-frequency switch 13 turned off, the resonant frequency band is shifted to a higher frequency band compared to the RFID communication band.

Here, when the center frequencies before and after the shifting are respectively set to F1 and F2, a shift rate is (F2−F1)/F1×100. The shift rate may be appropriately set, but may be set to 30% or more in order to prevent unnecessary reflected waves. When the shift rate is determined, the center frequency F2 of the shift band of the resonant frequency may be set in relation to the center frequency F1 of the RFID communication band used in communication with the reader device.

FIG. 2 is a view illustrating an example of the RFID communication band and the shift band of the resonant frequency.

For example, in the passive-type RFID of a UHF band, a 920-MHz band (in a range of 916.8 to 922.2 MHz) is used as the RFID communication band. When the RFID communication band is a 920-MHz band, if the shift band of the resonant frequency band is roughly a higher frequency band than a 1200-MHz band, the shift rate becomes 30% or more. In this case, the length of the first antenna element 11 is designed such that the shift band of the resonant frequency is roughly a higher frequency band than the 1200-MHz band. As a specific example, if the length L1 of the first antenna element 11 illustrated in FIG. 1 is 6.2 cm or less, the sum of L1+L2+L3 may be about 8 cm.

The high-frequency switch 13 may be formed of a semiconductor chip such as a gallium arsenide FET having small insertion loss in a high-frequency region. The high-frequency switch 13 formed of the gallium arsenide FET or the like has a slight fixed length. In the actual antenna design, the total length of the antenna may be designed to be a desired length by adjusting the length L2 of the second antenna element 12.

Next, the configuration of a control system of the RFID tag 1A according to the first embodiment will be described.

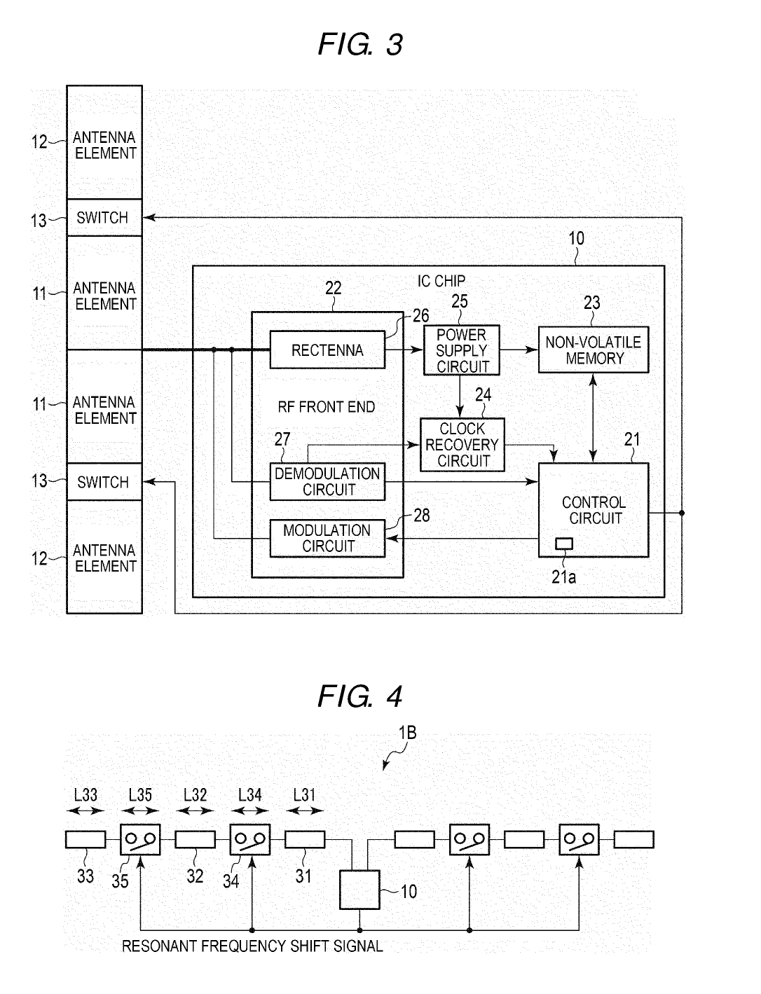

FIG. 3 is a block diagram illustrating the configuration example of the RFID tag 1A according to the first embodiment.

As illustrated in FIG. 3, the IC chip 10 of the RFID tag 1A includes a control circuit 21, an RF front end 22, a non-volatile memory 23, a clock recovery circuit 24, and a power supply circuit 25. The RF front end 22 of the IC chip 10 is connected to the first antenna element 11. The control circuit 21 of the IC chip 10 is connected to the high-frequency switch 13 provided between the first antenna element 11 and the second antenna element 12.

The control circuit 21 performs communication control, data processing, or the like. For example, the control circuit 21 realizes command analysis, state machine, timing control, and the like. In the configuration illustrated in FIG. 2, the control circuit 21 operates by power supplied from the power supply circuit 25. The control circuit 21 receives a clock from the clock recovery circuit 24 to operate. The control circuit 21 receives information indicating a signal received from the reader device from a demodulation circuit 27 and outputs, to a modulation circuit 28, a signal indicating information to be output to the reader device. In addition, the control circuit 21 accesses the non-volatile memory 23.

The control circuit 21 includes a register 21a. The register 21a sets a flag (an inventory flag) showing whether responding to the reader device is prohibited or whether responding to the reader device is possible. The inventory flag stored in the register 21a is in on state when responding to the reader device is prohibited and is in off state when responding to the reader device is possible. That is, the inventory flag stored in the register 21a is in the on state for a time (session time) according to session setting after responding to the inventory from the reader device.

The control circuit 21 outputs a signal instructing the high-frequency switch 13 to be turned on or off in response to the inventory flag stored in the register 21a. For example, when the inventory flag is in an on state, the control circuit 21 outputs a signal instructing the high-frequency switch 13 to be turned off. When the high-frequency switch 13 is turned on, the first antenna element 11 and the second antenna element 12 are electrically connected. In addition, the control circuit 21 outputs a signal instructing the high-frequency switch 13 to be turned on when the inventory flag is in an off state. When the high-frequency switch 13 is turned off, the first antenna element 11 and the second antenna element 12 are electrically disconnected.

The RF front end 22 processes the signal input or output through the antenna. In the configuration example illustrated in FIG. 3, the RF front end 22 includes a rectenna 26, the demodulation circuit 27, and the modulation circuit 28. The rectenna 26 rectifies and converts radio waves received by the antenna into DC currents. The rectenna 26 supplies the generated DC currents to the power supply circuit 25. The demodulation circuit 27 demodulates the radio waves received by the antenna. The demodulation circuit supplies the demodulated signal to the control circuit 21. The modulation circuit 28 modulates a signal (for example, ID information) indicating information to be transmitted. The modulation circuit 28 modulates the signal from the control circuit 21 and outputs the modulated signal to the antenna.

The non-volatile memory 23 is formed of a non-volatile memory device. The nonvolatile memory stores identification information (ID) assigned to the RFID tag, for example. The clock recovery circuit 24 generates a clock for operation based on the signal from the demodulation circuit 27. The clock recovery circuit 24 supplies the generated clock signal to the control circuit 21. The power supply circuit 25 supplies power for operation based on the DC current supplied from the rectenna 26.

Next, operation of the RFID tag 1A having the above-described configuration will be described.

In a standby state, the first antenna element 11 and the second antenna element 12 are electrically connected through the high-frequency switch 13. The first antenna element 11 and the second antenna element 12 electrically connected through the high-frequency switch 13 receive radio waves from the reader device as an antenna for communication. The radio waves received by the antenna are supplied to the RF front end 22. The rectenna 26 of the RF front end 22 converts the received radio waves into DC currents and supplies the DC currents to the power supply circuit 25. The power supply circuit 25 supplies the DC currents supplied from the rectenna 26 to the parts in the IC chip 10 as power for operation. The control circuit 21 in the IC chip 10 is activated by the power supplied from the power supply circuit 25.

The activated control circuit 21 sets a session time according to a command from the reader device received through the demodulation circuit 27. The control circuit 21 sets the inventory flag to the on state (a predetermined bit set in the inventory flag is changed from 0 to 1) which is stored in the register 21a when responding to the reader device through the modulation circuit 28 with information such as an ID. When the inventory flag is set to the on state, the control circuit outputs a signal (resonant frequency shift signal) instructing the high-frequency switch 13 to be turned off. Specifically, the control circuit 21 outputs the resonant frequency shift signal with a voltage capable of causing the high-frequency switch 13 to be turned off when the inventory flag is in the on state (a predetermined bit is 1).

The control circuit 21 monitors whether an elapsed time after responding to the reader device is passed the session time based on the clock supplied from the clock recovery circuit 24. The control circuit 21 sets the inventory flag to the off state when the elapsed time after responding exceeds the session time. When the inventory flag is in the off state, the control circuit 21 outputs a signal for turning on the high-frequency switch 13.

That is, the control circuit 21 sets the inventory flag according to session setting and outputs a signal (resonant frequency shift signal) in conjunction with the inventory flag to the high-frequency switch 13. The on or off state of the high-frequency switch 13 is determined by the resonant frequency shift signal in conjunction with the inventory flag. When the inventory flag indicating a non-responsive state is in the on state, the high-frequency switch 13 is turned off by the resonant frequency shift signal from the control circuit 21. When the high-frequency switch 13 is turned off, the first antenna element 11 and the second antenna element 12 are electrically disconnected. As a result, during a period in the non-responsive state, the resonant frequency of the antenna of the RFID tag 1A is set to a shift band (for example, a 1200-MHz band).

According to the first embodiment, the RFID tag switches on or off state of the switch inserted between the divided antenna elements in conjunction with the event flag. The RFID tag sets the inventory flag to the on state and turns off the switch to electrically disconnect the antenna elements in the non-responsive state with respect to the reader device. Therefore, the RFID tag in the non-responsive state can shorten the antenna elements by dividing the antenna elements with the switch, thereby reducing an effective aperture. As a result, the RFID tag in the non-responsive state can reduce reflection of the radio waves arriving at the antenna element and reduce interference waves with respect to the reader device.

### Second Embodiment

Next, a second embodiment will be described.

The RFID tag described in the first embodiment has a configuration in which the two-divided antenna elements are linked by the switch. In an RFID tag according to the second embodiment, an antenna element is divided into three or more antenna elements, and the divided antenna elements are linked by a plurality of switches. As the number of divided antenna elements is increased, the divided antenna elements may become shorter. As the antenna elements become shorter, the effective aperture may be made smaller so that reflection of radio waves arriving at each antenna element may be further reduced.

FIG. 4 is a view illustrating the configuration example of an RFID tag 1B according to the second embodiment.

The RFID tag 1B according to the second embodiment illustrated in FIG. 4 includes an IC chip 10, a first antenna element 31, a second antenna element 32, a third antenna element 33, a first high-frequency switch 34, and a second high-frequency switch 35.

The IC chip 10 of the RFID tag 1B illustrated in FIG. 4 may be realized by a passive-type chip having the same configuration as the IC chip illustrated in FIG. 1 or 3 described in the first embodiment. Accordingly, the detailed description of the IC chip 10 of the RFID tag 1B will be omitted. However, the IC chip 10 of the RFID tag 1B is connected to the first antenna element 31 as illustrated in FIG. 4. In addition, the control circuit 21 in the IC chip 10 of the RFID tag 1B is connected to the high-frequency switches 34 and 35.

The first antenna element 31, the second antenna element 32, and the third antenna element 33 are three-divided antenna elements. The high-frequency switches 34 and 35 link three antenna elements 31, 32, and 33 in series. In the example illustrated in FIG. 4, the high-frequency switch 34 is provided between the first antenna element 31 and the second antenna element 32. The high-frequency switch 35 is provided between the second antenna element 32 and the third antenna element 33.

The high-frequency switches 34 and 35 are switched on or off in response to a signal (resonant frequency shift signal) from the IC chip 10. When the high-frequency switches 34 and 35 are turned on, the first antenna element 31, the second antenna element 32, and the third antenna element 33 are electrically connected to form the entire antenna. When the high-frequency switches 34 and 35 are turned off, the first antenna element 31, the second antenna element 32, and the third antenna element 33 are electrically disconnected.

In the example illustrated in FIG. 4, the lengths of the first antenna element 31, the second antenna element 32, the third antenna element 33, the first high-frequency switch 34, and the second high-frequency switch 35 are L31, L32, L33, L34, and L35, respectively. In this case, the total length of L31, L32, L33, L34, and L35 may be designed to be about 8 cm corresponding to the RFID communication band. If the high-frequency switches 34 and 35 are semiconductor chips having slight lengths, the entire length of the antenna can be designed to a desired length by adjusting the lengths of the antenna elements 31, 32, and 33.

In the RFID tag 1B illustrated in FIG. 4, the control circuit 21 in the IC chip 10 outputs the resonant frequency shift signal to the high-frequency switches 34 and 35. The control circuit 21 outputs the resonant frequency shift signal in conjunction with the inventory flag stored in the register 21a, similarly to the first embodiment. That is, the control circuit 21 sets the inventory flag to the on state as a non-responsive state while the session time is elapsed after responding to the reader device. The control circuit 21 outputs the resonant frequency shift signal for turning off the high-frequency switches 34 and 35 when the inventory flag is in the on state (in the non-responsive state).

Accordingly, when the RFID tag 1B is in the non-responsive state, the high-frequency switches 34 and 35 are turned off according to the resonant frequency shift signal from the control circuit 21. When the high-frequency switches 34 and 35 are turned off, the antenna elements 31, 32, and 33 are electrically disconnected. The antenna elements 31, 32, and 33 are obtained by dividing the antenna element having a length corresponding to the RFID communication band into three elements. Since the antenna elements 31, 32, and 33 are shortened due to the three-division, the effective aperture becomes smaller.

As described above, the second embodiment is exemplified on the antenna used in the RFID tag having the configuration in which the plurality of switches are inserted and the antenna element is divided into three or more antenna elements. In the RFID tag according to the second embodiment, as the number of antenna elements divided through the plurality of switches is increased, the divided antenna elements become shorter. As a result, as each antenna element becomes shorter, the effective aperture becomes smaller, and the effect of reducing reflection of radio waves arriving at the antenna element can be enhanced.

Although the first and second embodiments are described, these are merely exemplary and do not limit the scope of the invention. For example, although the antenna element is divided into three elements in the second embodiment, the antenna element may be divided into four or more elements by increasing the number of high-frequency switches. In addition, each antenna element does not need to be linear as illustrated in FIG. 1 or 4 and may be bent or curved.

The RFID tag according to the above-described embodiment includes a passive-type IC chip, an antenna element divided into a plurality of elements, and a switch inserted between the antenna elements. The IC chip controls the switches in conjunction with flag information indicating that the RFID tag is in a non-responsive state for a specified time as a result of responding to a telegraphic message from the reader device.

In addition, in the RFID tag according to the embodiment, if the divided antenna elements are connected through the switch, the total length of the antenna connected to the IC chip is included in the wavelength of the communication frequency band with the reader device. Further, in the RFID tag according to the embodiment, if all or some of the switches are in a disconnection state, the resonant frequency of the total length of the antenna connected to the IC chip is included in a higher frequency band compared to the above-described communication frequency band.

According to the above-described embodiments, even if RFID tags are arranged at high density, the antenna aperture area of the RFID tag after responding becomes small and an overlapping area is reduced. Therefore, each RFID tag can receive necessary power from radio waves sent from the reader device, and the response of each RFID tag becomes reliable. Since the antenna element of the RFID tag after responding is shortened due to division, unnecessary reflected power from each antenna element is reduced. As a result, interference waves with respect to the reader device from the RFID tag, which already responded to the reader device, can be reduced and reception operation by the reader device becomes reliable.

In other words, even if the RFID tags according to the embodiments are arranged at high density, the overlooking by the reader device can be reduced. Since the reader device is able to efficiently recognize the RFID tag with little error, it is possible to improve the operational efficiency for such as inventory or inspection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An RFID tag comprising:
a plurality of antenna elements;
a switch positioned between the plurality of antenna elements; and
a control circuit configured to turn off the switch until a specified time elapses after responding to radio waves from a reader device.

2. The tag according to claim 1, further comprising:
a register configured to store flag information being in an ON state when responding to the radio waves from the reader device and being in an OFF state when the specified time elapses after the responding,
wherein the control circuit controls the switch in conjunction with the flag information.

3. The tag according to claim 1, further comprising:
a passive-type IC chip connecting one end of each of the plurality of antenna elements linked through the switch,
wherein the IC chip includes the control circuit.

4. The tag according to claim 1, wherein
a total length when the plurality of antenna elements are connected through a plurality of switches is included in a wavelength of a frequency band for communication with the reader device, and a resonant frequency with a length of each antenna element when the plurality of antenna elements are electrically disconnected by the switches becomes a higher frequency band compared to a frequency band for communication.

5. The tag according to claim 1, wherein
a plurality of switches are provided, and
a total length when three or more antenna elements are linked through the plurality of switches is included in a wavelength of a frequency band for communication with the reader device.

6. The tag according to claim 1, wherein
the switch is a high frequency switch.

7. The tag according to claim 1, wherein
the switch comprises a gallium arsenide FET.

8. The tag according to claim 1, wherein
the switch is configured to electrically connect the plurality of antenna elements in an ON state and electrically disconnect the plurality of antenna elements in an OFF state.

9. The tag according to claim 1, wherein
the RFID tag is a passive type RFID tag.

10. An RFID tag comprising:
a plurality of at least three antenna elements;
a plurality of at least two switches each positioned between a different set of two antenna elements; and
a control circuit configured to turn off the plurality of switches until a specified time elapses after responding to radio waves from a reader device.

11. The tag according to claim 10, further comprising:
a register configured to store flag information being in an ON state when responding to the radio waves from the reader device and being in an OFF state when the specified time elapses after the responding,
wherein the control circuit controls the plurality of switches in conjunction with the flag information.

12. The tag according to claim 10, further comprising:
a passive-type IC chip connecting one end of each of the plurality of antenna elements linked through the plurality of switches,
wherein the IC chip includes the control circuit.

13. The tag according to claim 10, wherein
a total length when the plurality of antenna elements are connected through a plurality of switches is included in a wavelength of a frequency band for communication with the reader device, and a resonant frequency with a length of each antenna element when the plurality of antenna elements are electrically disconnected by the plurality of switches becomes a higher frequency band compared to a frequency band for communication.

14. The tag according to claim 10, wherein
the plurality of switch are configured to electrically connect the plurality of antenna elements in an ON state and electrically disconnect the plurality of antenna elements in an OFF state.

15. The tag according to claim 10, wherein
the RFID tag is a passive type RFID tag.

16. A method of mitigating interference when reading an RFID tag from a group of RFID tags densely arranged, comprising:
turning off a switch positioned between a plurality of antenna elements until a specified time elapses after responding to radio waves from a reader device.

17. The method according to claim 16, further comprising:
storing flag information being in an ON state when responding to the radio waves from the reader device and being in an OFF state when the specified time elapses after the responding,
wherein turning off the switch is performed in conjunction with the flag information.

18. The method according to claim 16, wherein
a total length when the plurality of antenna elements are connected through a plurality of switches is included in a wavelength of a frequency band for communication with the reader device, and a resonant frequency with a length of each antenna element when the plurality of antenna elements are electrically disconnected by the switches becomes a higher frequency band compared to a frequency band for communication.

19. The method according to claim 16, wherein
turning off the switch comprises turning off a plurality of switches, and
a total length when three or more antenna elements are linked through the plurality of switches is included in a wavelength of a frequency band for communication with the reader device.

20. The method according to claim 16, further comprising:
at least one of electrically connecting the plurality of antenna elements in an ON state and electrically disconnecting the plurality of antenna elements in an OFF state.
